(19) United States
(12) Patent Application Publication
(10) Pub. No.: US 2009/0108624 A1
(43) Pub. Date: Apr. 30, 2009

(54) Automobile hail auto, pick-up, SUV, and RV cover to help prevent damage vehicles during hail storms

(76) Inventor: Glen Ralph Hunt, Denton, TX (US)

Correspondence Address: GLEN RALPH HUNT, 3312 ORIOLE LANE, DENTON, TX, 76209, US

(21) Appl. No.: 11/825,858

(22) Filed: Oct. 24, 2007

(51) Int. Cl. B60J 11/00

(52) U.S. Cl. 296/136.1

(57) ABSTRACT

The protective cover for vehicles against hail or other foreign objects is an inflatable device that can be placed over an entire vehicle to prevent any damage to the exterior of the vehicle. The cover can be folded and stored in the trunk of the vehicle and can be easily installed by one person. The cover comes with an air pump that can be directly connected to the vehicle's battery as well as a low and high pressure control valve to keep the cushion inflated to the optimal pressure. The air cushion is held in place by a vinyl car cover that has straps to hold the cover in place despite any wind, rain, or other weather conditions.

### BACKGROUND OF THE INVENTION

Because of such widespread hail damage to vehicles in the United States and the amount of claims paid by insurance companies, the hail car cover is a necessity as many vehicles are parked on streets and not garage kept.

This invention relates to the field of apparatus for an inexpensive one piece inflatable air blanket covering the entire vehicle. We provide a new Nylon vehicle cover that, when pulled tight over the air blanket, will allow hail to bounce off and help prevent damage to the vehicle during a hail storm. The air blanket is activated by a 110 volt air blower powered from home or business, or a 12 volt air blower powered by vehicle battery.

We provide a wire harness consisting of two (2) wires, one red wire to positive post on battery and one black wire to negative post on battery. Both wires run behind the grill with male and female ends to prevent shorting out the air blower.

Our low and high pressure control valve allows the air blanket to remain between the two (2) preset air pressures. In the event air pressure drops, the air pump will activate and replenish air.

### BRIEF SUMMARY OF THE INVENTION

The object of this invention is to completely cover entire vehicle for protection from hail or falling objects.

The air blanket and car cover are inexpensive and easy for one person to install.

The air blanket is of one piece, made of durable material and can be deflated and stored in trunk for use away from home.

We provide the air pump, 110 volt powered from home or business, or 12 volt powered from vehicle battery.

We provide a wire harness consisting of two (2) wires, one red to positive post on battery and one black wire to negative post on battery. Both wires run behind the grill with a male and female ends to prevent shorting out air blower.

Our low and high pressure control valve allows air blanket to remain between the two (2) preset air pressures. In the event air pressure drops, the air pump will activate and replenish air.

### BRIEF DESCRIPTION OF THE SEVERAL VIEWS OF THE DRAWINGS

FIG. 1. Air Blanket

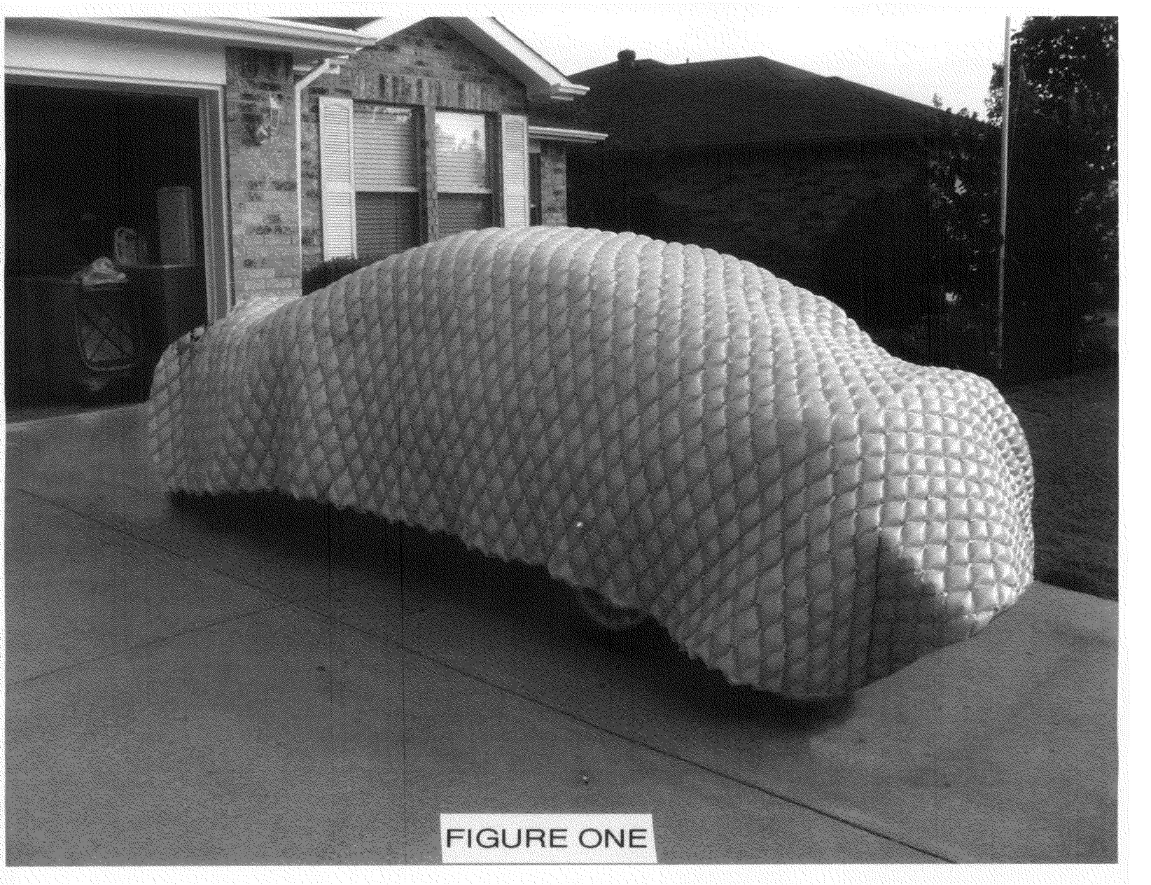

FIG. 2. Vinyl car cover that goes over the hail air blanket

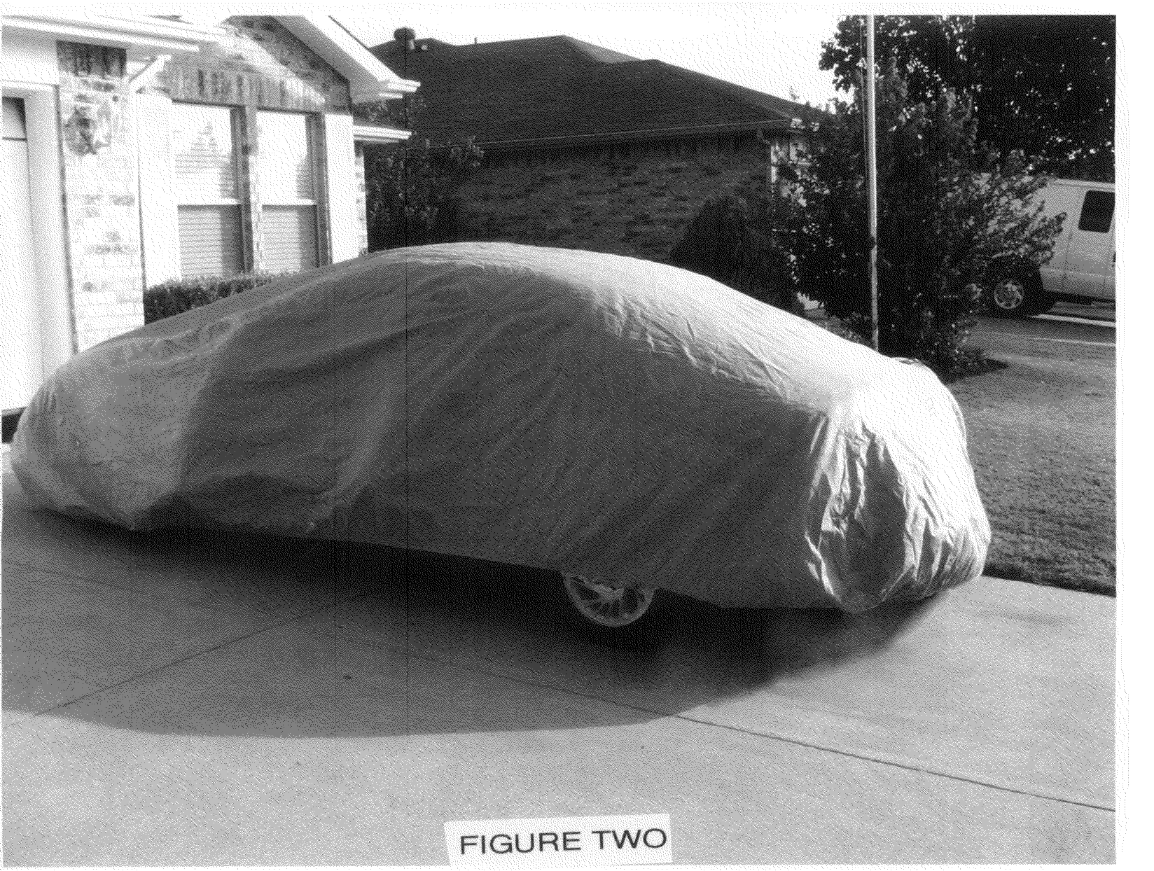

FIG. 3. Air Blower, Both 110 volt and 12 volt.

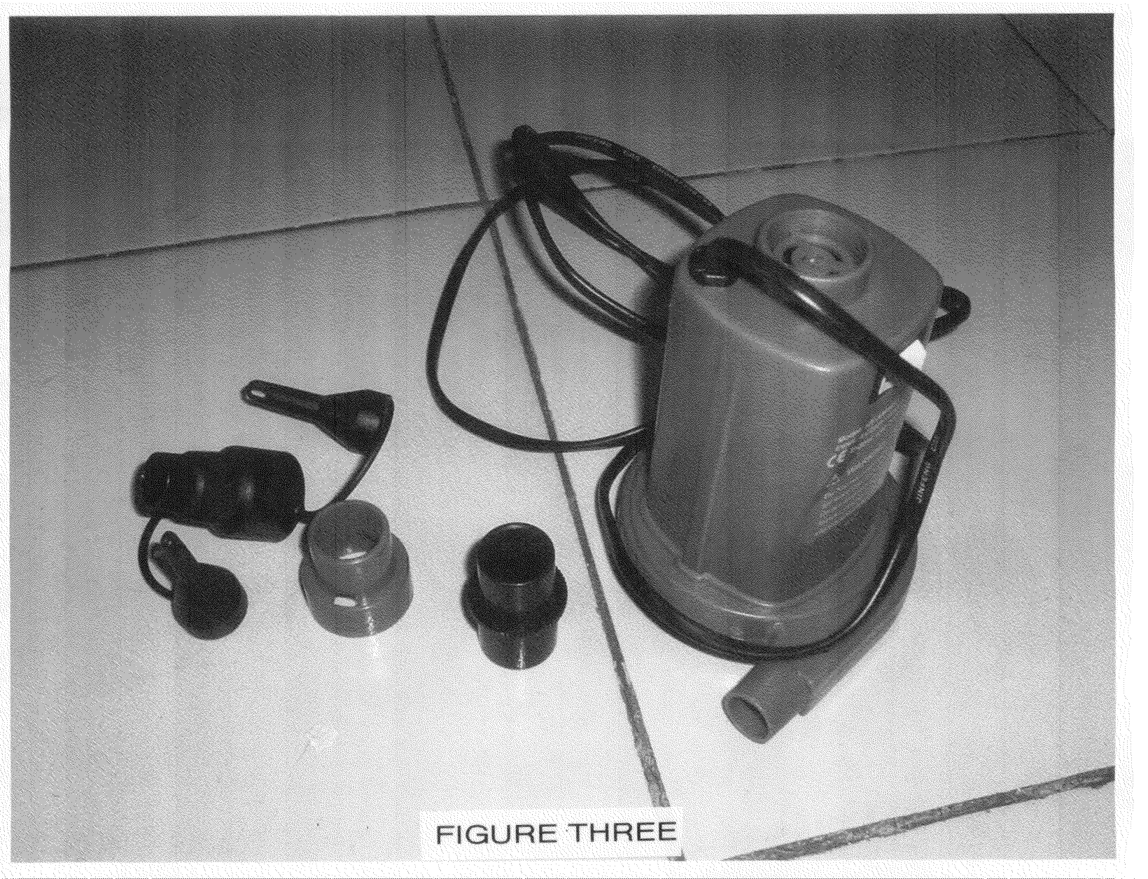

### DETAILED DESCRIPTION OF THE INVENTION

The protective blank consists of two (2) large sheets of man-made material, example; any polymer, VINYL or plastic that would be sealed on all sides to prevent the escape of air or expanding gases. The protective blanket will be capable of receiving with the intent to hold air or gases. The protective blanket would expand to its full measurement with the insertion of air or gas and would hold its shape of a large rectangular by bonding the top layer to the bottom layer using a geometric pattern.

The protective blanket would be of such size that when unfolded does reach from bumper to bumper and rocker panel to rocker panel of the vehicle. A commercial vehicle cover for automobiles, pickups, boats, and recreational vehicles would be placed over the protective blanket and secured using the hold downs provided the car cover. The protective blanket would give added defense of the vehicle in the event of inclement weather during a hail storm. The protective blanket would be deflated, folded and stored in your trunk for use away from home.

The air blanket is activated by a 110 volt air blower powered from home or business, or a 12 volt air blower powered by vehicle battery. This air blower also has a reverse setting to deflate the protective blanket.

We provide a wire harness consisting of two (2) wires, one red wire to positive post on the battery, and one black wire to negative post on battery. Both wires run behind the grill with a male and female ends to prevent shorting out air blower.

Our low and high pressure control valve allows air blanket to remain between the two (2) preset air pressures. In the event air pressure drops, the air pump will activate and replenish air.

1. Our protective blanket covers vehicle from bumper to bumper and rocker panel to rocker panel to protect entire vehicle from damage during a hail storm.

2. We provide the inflatable three (3) inch thick air protective blanket and a new car cover with straps going under vehicle to prevent wind blowing it off during a storm. A tight car cover over the air blanket will allow hail to bounce off helping to prevent damage during a storm.

3. Our air protective blanket is constructed of heavy duty man-made material and light weight enough for one person to install.

4. Our air blower can inflate with 110 volt powered from home or business, or 12 volt powered from vehicle battery.

5. Our low and high pressure control valve allows air protective blanket to remain between the two (2) preset air pressures. In the event air pressure drops, the air pump will activate and replenish air.
